(19) United States
(12) Patent Application Publication
(10) Pub. No.: US 2003/0035529 A1
(43) Pub. Date: Feb. 20, 2003

(54) Presence detection by screen saver method and apparatus

(76) Inventor: Charles Baker, Apex, NC (US)

Correspondence Address: James & Sze, Pillsbury Winthrop LLP, Intellectual Property Group, 11682 El Camino Real Suite 200, San Diego, CA, 93102, US

(21) Appl. No.: 09/930,038

(22) Filed: Aug. 14, 2001

(51) Int. Cl. H04M 3/42

(52) U.S. Cl. 379/211.02

(57) ABSTRACT

A method and apparatus recognizing that inactivity monitors, such as screen savers, may be used to determine the presence of a call recipient. When the call recipient is not present, calls may be forwarded to other destination devices or to voice mail.

### BACKGROUND

Field of the Invention

Aspects of the present invention relate in general to packet-based telephony, and an apparatus, and method to determine the presence or location of a call recipient at an internet access device.

### BRIEF DESCRIPTION OF THE DRAWINGS

FIG. 1 illustrates an embodiment of a system that determines the presence or location of a call recipient at an Internet Access Device (IAD).

FIG. 2 is an act diagram of an apparatus determines the presence or location of a call recipient at an internet access device.

FIG. 3 is an act diagram of an apparatus that facilitates telephony management via a web-enabled call-interface.

FIGS. 4A-4B are diagrams of a web-enabled call-interface configured to determine the presence or location of a call recipient at an internet access device.

FIG. 5 is a flowchart of a method that determines the presence or location of a call recipient at an internet access device.

### DETAILED DESCRIPTION

What is needed is an easy-to-use apparatus and method capable of determining the presence or location of a call recipient at Internet Access Device (IAD).

Aspects of the present invention include an easy-to-use apparatus, method, and a web-enabled call-interface capable of determining the presence or location of a call recipient at an internet access device. One aspect of the invention is the correlation of an inactive user interface with the absence of a potential call user. When the call recipients receive calls, they may do so at the internet access device. Thus, when a computer or internet access device is running an inactivity monitor program, the call recipient is probably not located at the internet access device. When the call recipient's presence is no longer detected at an internet access device, the recipient's calls are automatically forwarded to another location, without call recipient intervention or even attempting to “ring” the internet access device.

The term “call,” as used herein, may refer to audio (e.g., telephone), video, text (e.g. “instant text messaging” services) and multimedia based messages, or any other packet-based message communication as is known in the art.

Calls may include those calls received by an Internet Access Device (IAD) internet access device in conjunction with an Intelligent Network (IN) or Next Generation Network (NGN).

Furthermore, it is understood that calls may include those calls received at traditional public switch telephone network (PSTN) phones, and that the embodiments of the present invention may also include PSTN, Private Branch Exchange (PBX), Centrex business phones, and plain old telephone service (POTS) telephones. It is understood that the use of internet access device embodiments, as described below, are for illustrative purposes only, and that other embodiments, limited only by the claims, may exist. These embodiments include, but are not limited to, PSTN, PBX, Centrex business phone, and POTS embodiments.

Calls are any real-time or near-real-time audio, video, text, and multimedia-based message transmissions that take place over a computer network (i.e., an “on-line” message transmission). Examples of such transmissions include, but are not limited to, any call recipient-to-call recipient or call recipient-to-multi-call recipient communication that involves the electronic conveying of digital-packet messages. An example of such a call includes a electronic text “chat” or “talk” messaging, electronic-mail, video-conferencing, internet telephony (“voice over internet protocol”), or instant text messaging.

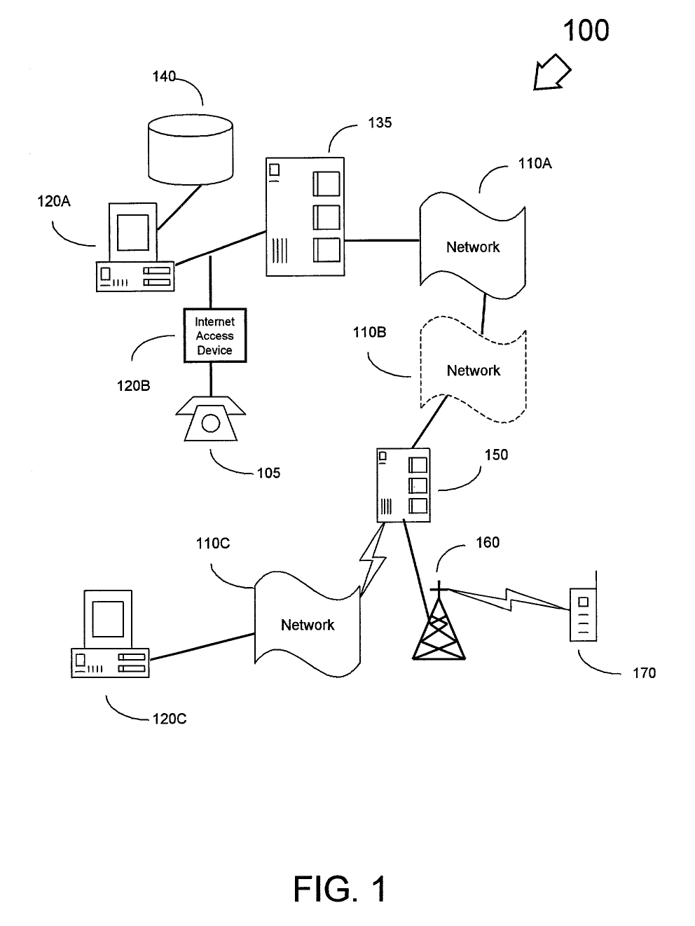

FIG. 1 is a simplified functional act diagram depicting system 100, constructed and operative in accordance with an embodiment of the present invention. System 100 is configured to determine the presence or location of a call recipient at Internet Access Device (IAD).

The method identifies whether the call recipient is present at the internet access device 120, and unregisters the IAD 120, preventing the IAD 120 from receiving calls, when the call recipient is not present.

In system 100, internet access devices 120 are connected via a communications network 110. Callers may communicate to call recipients via internet access devices 120, telephones 105 coupled to internet access devices 120, or wireless phones 170. It is understood by those known in the art, that either such device may be coupled via a single or multiple number of networks 110 A-C.

In some embodiments, internet access device 120 may be a personal computer, personal digital assistant (PDA), wireless phone, or other such network-computing device.

The network 110 may also include other networkable devices known in the art, such as other internet access devices 120, storage media 140, an application server 135, telephone server 150 and wireless telephone base station 160. It is well understood in the art, that any number or variety of computer networkable devices or components may be coupled to the network 110 without inventive faculty. Examples of other devices include, but are not limited to, servers, computers, workstations, terminals, input devices, output devices, printers, plotters, routers, bridges, cameras, sensors, or any other such device known in the art.

Internet access device 120 may be any apparatus known in the art that are able to communicate on the network 110.

Network 110 may be any communication network known in the art, including the Internet, a local-area-network (LAN), a wide-area-network (WAN), or any system that links a computer to an internet access device 120. Further, network 110 may be of configured in accordance with any topology known in the art, including star, ring, bus, or any combination thereof.

Application server 135 is connected to a telephone network 110A that supports the receipt and transmission of digital packets. Telephone network server 150 may be configured to allow different networks 110B and 110C to communicate, as well as communicate with a public switch telephone network (PSTN), plain old telephone service (POTS), Integrated Services Digital Network (ISDN), or any other telephone network. As shown in FIG. 1, telephone network server 150 may be coupled to wireless base station 160, which allows communication to wireless phone 170.

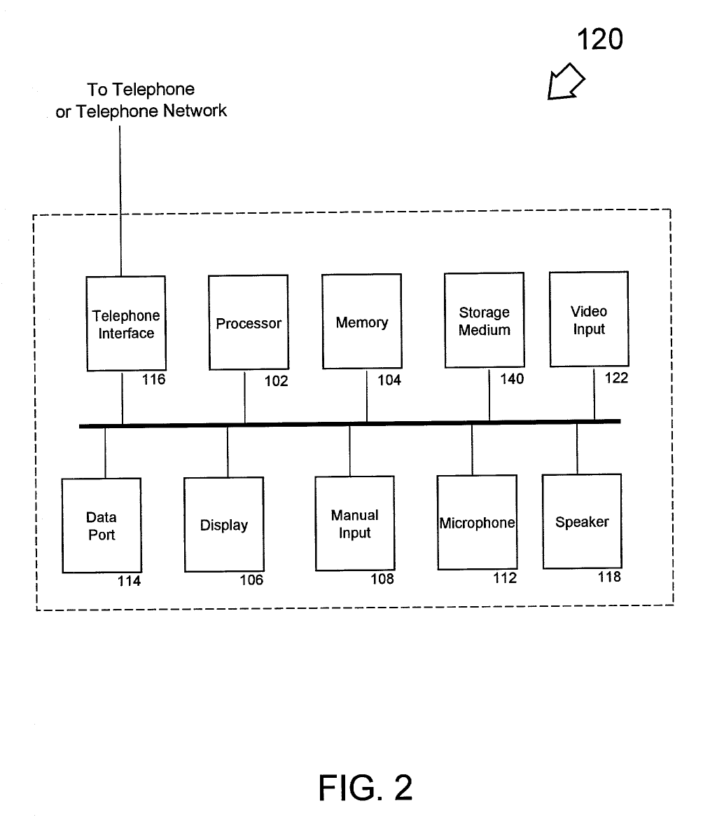

Embodiments will now be disclosed with reference to a functional act diagram of an exemplary internet access device 120 of FIG. 2, constructed and operative in accordance with an embodiment of the present invention. Internet access device 120 may run a real-time multi-tasking operating system and includes at least one processor or central processing unit (CPU) 102. Processor 102 may be any microprocessor or micro-controller as is known in the art.

The software for programming the processor 102 may be found at a computer-readable storage medium 140 or, alternatively, from another location across network 110. Processor 102 is connected to computer memory 104. Internet access device 120 may be controlled by an operating system (OS) that is executed within computer memory 104.

Processor 102 communicates with a plurality of peripheral equipment, including telephone interface 116. Additional peripheral equipment may include a display 106, manual input device 108, storage medium 140, microphone 112, video input 122, and data port 114.

Display 106 may be a visual display such as a cathode ray tube (CRT) monitor, a liquid crystal display (LCD) screen, touch-sensitive screen, or other monitors as are known in the art for visually displaying images and text to a call recipient.

Manual input device 108 may be a conventional keyboard, keypad, mouse, trackball, or other input device as is known in the art for the manual input of data.

Storage medium 140 may be a conventional read/write memory such as a magnetic disk drive, floppy disk drive, compact-disk read-only-memory (CD-ROM) drive, transistor-based memory or other computer-readable memory device as is known in the art for storing and retrieving data. Significantly, storage medium 140 may be remotely located from processor 102, and be connected to processor 102 via a network 110 such as a local area network (LAN), a wide area network (WAN), or the Internet.

Microphone 112 may be any suitable microphone as is known in the art for providing audio signals to processor 102. In addition, a speaker 118 may be attached for reproducing audio signals from processor 102. Video input 122 may be a digital or analog video camera device to record still or moving images. In some embodiments, video input 122 may be a scanner device. It is understood that microphone 112, speaker 118, and video input 122 may include appropriate digital-to-analog and analog-to-digital conversion circuitry as appropriate.

Data port 114 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data port 114 may be any interface as known in the art for communicating or transferring files across a computer network, examples of such networks include Transmission Control Protocol/Internet Protocol (TCP/IP), Ethernet, Fiber Distributed Data Interface (FDDI), token bus, or token ring networks. In addition, on some systems, data port 114 may consist of a modem connected to telephone interface 112. Similarly, telephone interface 112 provides connectivity to internet access device 120 to communicate with a telephone network 150. Thus, the telephone network interface 112 allows the internet access device 120 to communicate and process input and output from a telephone line.

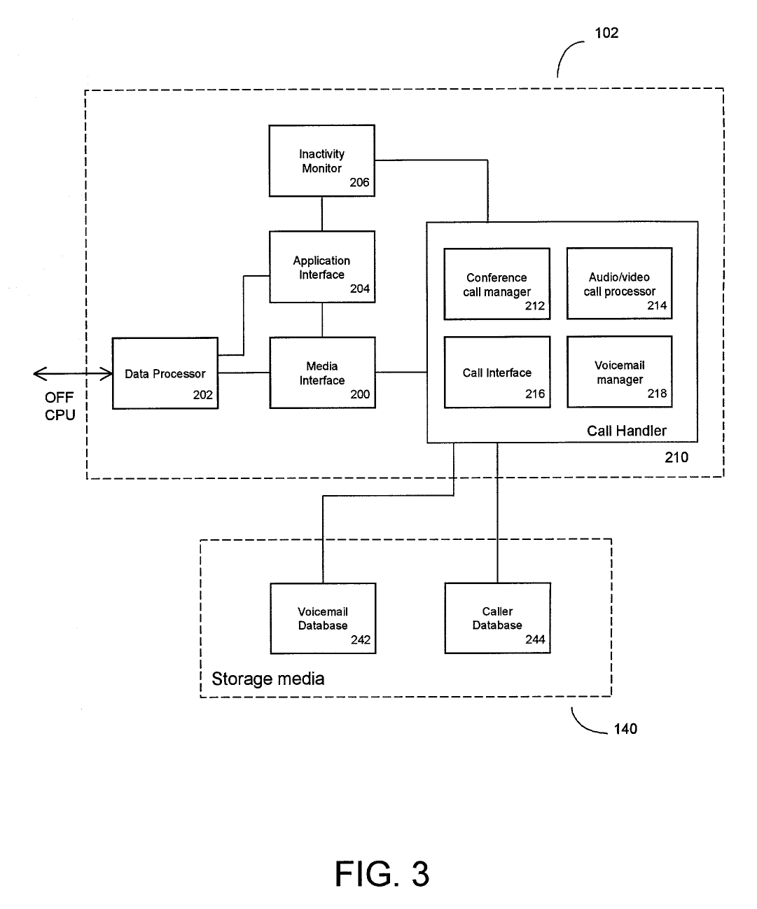

FIG. 3 is an expanded functional act diagram of CPU 102 and storage medium 140. It is well understood by those in the art, that the functional elements of FIG. 3 may be implemented in hardware, firmware, or as software instructions and data encoded on a computer-readable storage medium 140. As shown in FIG. 3, central processing unit 102 is functionally comprised of a data processor 202, an application interface 204, a media interface 200, an inactivity monitor 206, and a call handler 210. These structures may be implemented as hardware, firmware, or software encoded on a computer readable medium, such as storage media 140. In addition, as shown in FIG. 3, storage media 140 may also contain a voice mail database 242, and a caller database 244.

Data processor 202 interfaces with display 106, manual input device 108, storage medium 140, microphone 112, data port 114, video input 122, Internet data port 114, and telephone network interface 112. The data processor 202 enables processor 102 to locate data on, read data from, and write data to, these components.

Application interface 204 enables processor 102 to take some action with respect to a separate software application or entity. For example, application interface 204 may take the form of a windowing call recipient interface, as is commonly known in the art.

Inactivity monitor 206 is any structure known in the art that registers the inaction of a user using internet access device 120. In some embodiments, inactivity monitor 206 may be a screen saver, as is known in the art, which displays random images on display 106. In such an embodiment, inactivity monitor 206 waits for a predetermined or set-able time period of non-activity from manual input 108 or application interface 204. After the predetermined time period has elapsed without activity, inactivity monitor 206 informs call handler 210 of the inactivity.

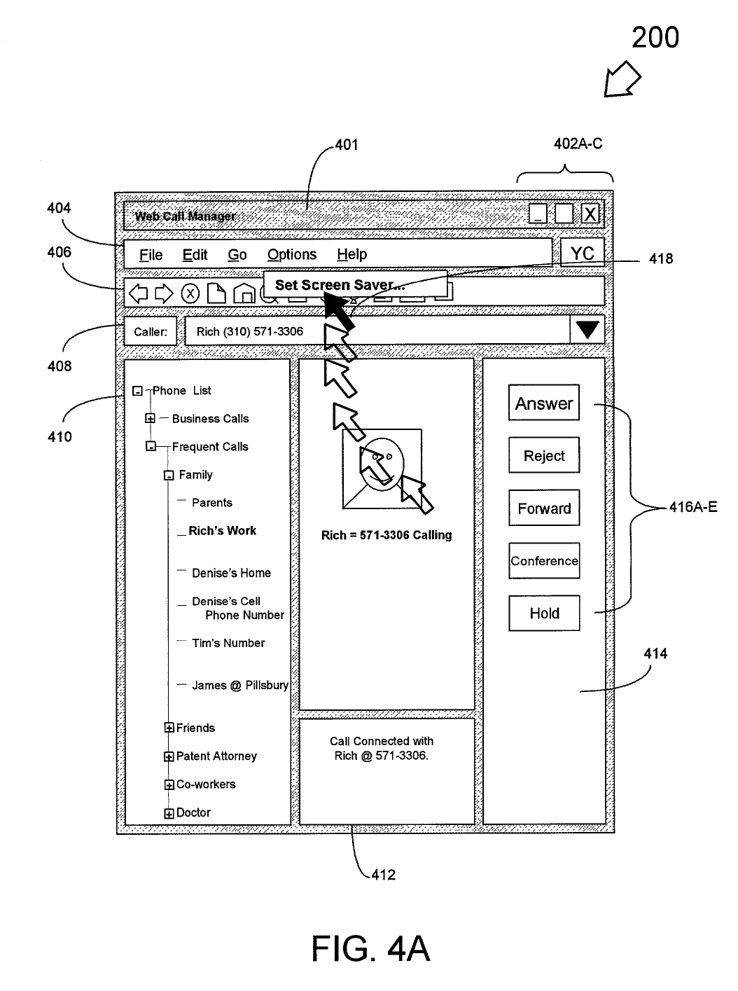

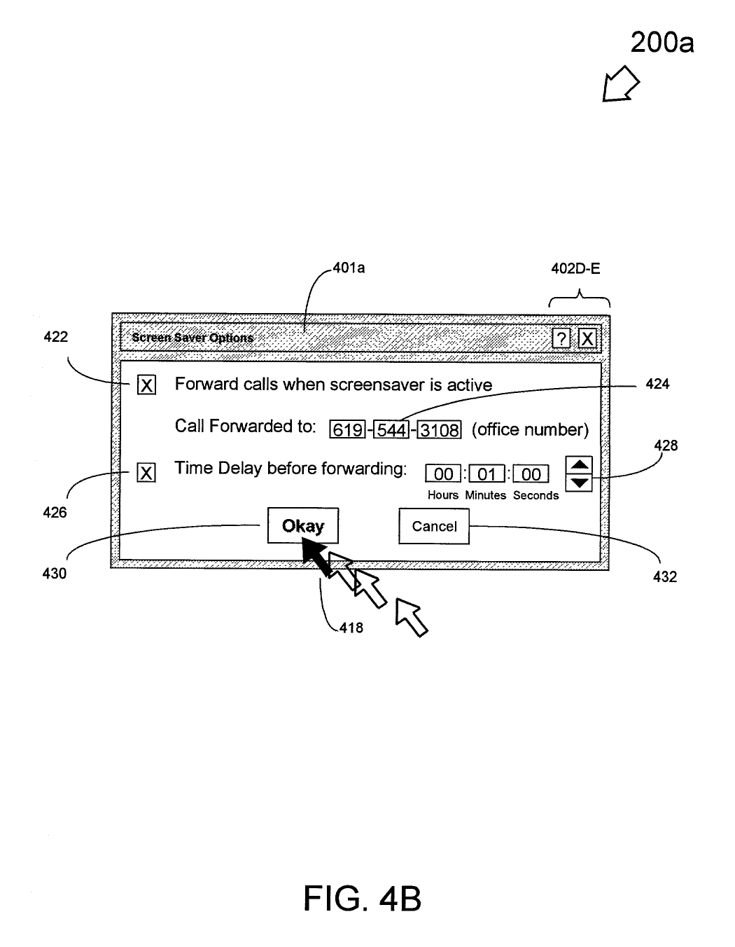

Media interface 200 is a web-enabled call interface. In some embodiments, the media interface 200 may be stand-alone program, or a web-browser window. An example of such a web browser window is shown in FIG. 4. Web browser window 200 comprises title bar 401, window control buttons 402A-C, menu bar 404, button bar 406, address bar 408, phone-list frame 410, main frame 420, status frame 412, and control frame 414.

In some embodiments, main frame 420 displays a picture of the current caller retrieved from a caller database 244. In such embodiments, using the mouse pointer 418, call recipients may either click control buttons 416A-E, or “drag-and-drop” callers listed in the phone list frame 410, or pictures of the caller in the main frame 420 to control buttons 416A-E in the control frame 414. Media interface 200 then selects the appropriate structure to execute the functionality specified by the control button 416. In some embodiments, call recipients may click a “forward” control button 416C or select a menu bar 404 option to engage the forwarding of calls.

In some embodiments, media interface 200 may be a dialog box 200a or similar type of window, either in conjunction with or in lieu of web browser window. Dialog box 200a comprises title bar 401a, check boxes 422, 426, input boxes 424, option scroll bar 428, okay button bar 430, and cancel button 432. In such embodiments, using the mouse pointer 418, call recipients may either click check boxes 422, 426 to indicate that calls should be forwarded when an inactivity monitor is active, and indicate a time delay before forwarding the call, if appropriate.

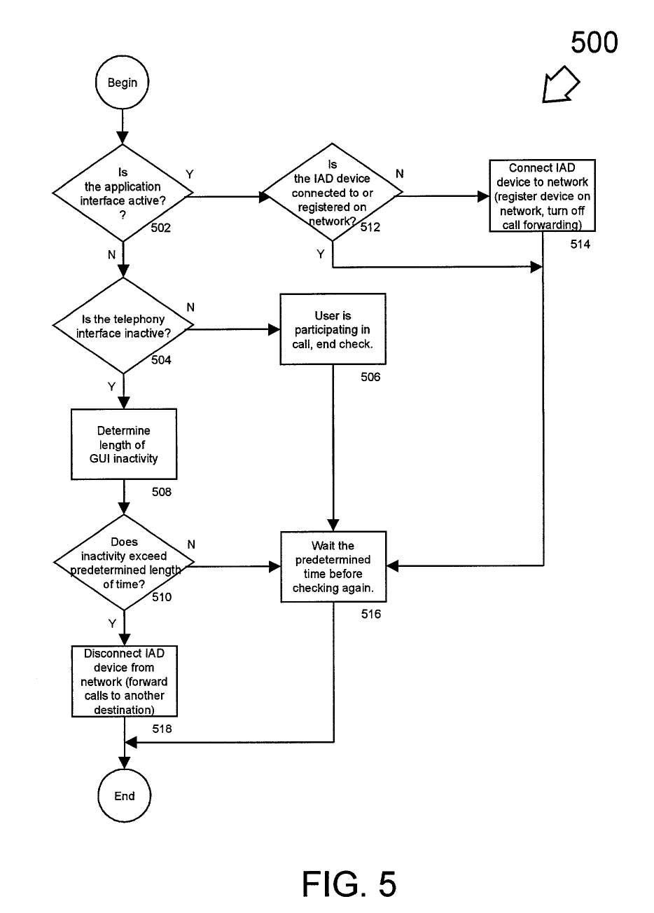

Returning to FIG. 3, call handler 210 may further comprise a conference call manager 212, an audio/video call processor 214, a call interface 216, and a voice mail manager 218. Conference call manager 212 allows media interface to 200 communicate with multiple parties in a conference call. Audio/video call processor allows media interface to utilize video input 122, microphone 122, speaker 118 and display 106 for audio or multimedia-video-based calls. Call interface 216 provides call handler 210 an interface to telephone network. For example, call interface 216 connects, registers, or interfaces an internet access device 120 as an active device on a network 110, indicating that internet access device 120 may be a valid recipient of a call. When the internet access device is disconnected or deregistered from the network 110, the internet access device 120 is no longer a valid call recipient. Voice mail manager 218 communicates with media interface 200 and stores messages in a voice mail database 242. For example, voice mail manager 218 may answer calls, record messages left from callers, or, in some embodiments, forward calls to other destinations. These components of call handler 210 interact with a voice mail database 242, and a known caller database 244, and may best be understood with respect to the flowchart of FIG. 5, as described below.

FIG. 5 flowcharts a process 500 to determine the presence or location of a call recipient at Internet Access Device (IAD), constructed and operative in accordance with an embodiment of the present invention. It is understood that the method discussed herein may be implemented in relationship to a number of different protocols, including a public switch telephone network (PSTN), plain old telephone service (POTS), Integrated Services Digital Network (ISDN), SIP (Session Initiation Protocol), International Telecommunications Union (ITU) H.323, Real Time Transport Protocol (RTTP), any Voice Over Internet Protocol standard, or any other telephone network

At act 502, a determination is made on whether the application interface 204 is active. In some embodiments, inactivity monitor 206 determines if application interface 204 has been inactive for a threshold time period. This threshold time period may be set in dialog box 200a or through any other method as is known in the art. If the application interface 204 has been active, the call recipient is assumed to be at the internet access device 120, and flow continues at act 512. If the application interface 204 has been inactive, the call recipient is assumed not to be at the internet access device 120, flow continues at act 504.

When the call recipient is assumed to be at the internet access device 120, the internet access device 120 is deemed to be a valid call address. At act 512, a determination is made on whether the IAD device connected to or registered on network 110 as a valid call address.

In the case of an SIP-based internet access device 120, the SIP protocol has a special message for registering the internet access device 120 into the network. Since SIP is ASCII-based, the actual text of the SIP message used as the keyword for SIP registers is the word “REGISTER.” In SIP terminology this is called the Register “Method.” There are just a handful of SIP Methods, such as “INVITE” for initiating calls, “BYE” and “CANCEL” to terminate a call, and “ACK” to acknowledge the successful reception of transaction. More information about the Internet Engineering Task Force (IETF) draft for the SIP specification can be found in Request For Comments (RFC) 2543, located at http://www.ietf org/rfc/rfc2543.txt?number=2543. Equivalent acts may be used in the case of ITU H.323, any other Voice Over Internet Protocol or telephone network.

An entity that lives in the network is a SIP Registrar. The Registrar is provided as a centralized component that can perform numerous functions, such as authenticating the internet access device 120 during registration. In this process, the registrar looks up the internet access device 120 to see if it is a known subscriber. In a simple example of a SIP Register message flow, an internet access device 120 would send an SIP register to the network SIP registrar, the SIP register containing the device name, location, and contact information. The Network SIP registrar would respond with an “OK” acknowledgement once the end device was registered.

Once the internet access device 120 registers into the network via the SIP Registrar, then the internet access device 120 is effectively available to originate and terminate calls.

If the IAD 120 is connected to or registered on network 110 as a valid call address, flow continues at act 516. If not, call interface 216 registers internet access device 120 as a valid call address on network 110 at act 514, and flow continues at act 516. At act 516, internet access device waits a predetermined amount of time before the process may begin again. The process 500 then ends.

When the call recipient is initially assumed not to be at the internet access device 120, the assumption must be checked before the internet access device 120 is determined to be an invalid call address or unregistered from network 110. At act 504, a verification check is performed to determine whether call recipient is presently utilizing internet access device in any capacity 120, for example, the telephony interface (i.e., the call recipient is engaged in a call). Other verification checks, such as other forms of active data input other than from manual input 108 may be used. In some embodiments, a sensor device may be used to detect the presence of call recipient near internet access device 120.

If the call recipient is present, and for example, participating in a call, the check is ended at 506, and a predetermined time is waited before restarting process 500.

If the call recipient is not present, the length of application interface inactivity is determined, act 506. When the inactivity exceeds a predetermined length of time, the internet access device is disconnected or “deregistered” as a valid call address from the network, and calls may be subsequently forwarded to another destination or sent automatically to be processed by voice mail manager 218. In some embodiments using the Session Initiation Protocol, this may be accomplished by a deregistration call.

The SIP protocol also allows the end device to deregister by re-using the SIP Register with a “deregister” parameter. Therefore, the device can make itself “unavailable for calls” by deregistering from the SIP Registrar. Equivalent acts may be used in the case of ITU H.323, any other Voice Over Internet Protocol or telephone network.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. An apparatus comprising:
an inactivity monitor configured to determine the inactivity of an application interface;
a telephone interface configured to connect the apparatus to a network and configured to receive calls from the network;
a call interface, coupled to the inactivity monitor and the telephone interface, configured to deregister the telephone interface from receiving calls when the inactivity monitor determines that the application interface is inactive.

2. The apparatus of claim 1, wherein the received calls are automatically forwarded when the call interface deregisters the telephone interface from receiving calls.

3. The apparatus of claim 2, wherein the calls the received calls are automatically forwarded to another device.

4. The apparatus of claim 3, further comprising:
a voice mail manager, coupled to the call interface, the received calls being optionally automatically forwarded to the voice mail manager.

5. The apparatus of claim 3, wherein the deregistration occurs through the Session Initiation Protocol.

6. The apparatus of claim 3, wherein the inactivity monitor is a screen saver.

7. A method comprising:
determining the inactivity of an application interface;
receiving calls from a network;
automatically forwarding the received call when the application interface is inactive.

8. The method of claim 7, wherein the inactivity of the application interface is determined through a screen saver.

9. The method of claim 8, wherein the automatic forwarding is accomplished through deregistering a telephone interface from receiving calls.

10. The method of claim 9, wherein the received call is forwarded is to another device.

11. The method of claim 9, wherein the received call is forwarded is to voice mail.

12. The method of claim 9, wherein deregistering of the telephone interface is accomplished through the Session Initiation Protocol.

13. A computer-readable medium encoded with data and instructions, the data and instructions causing an apparatus executing the instructions to:
determine the inactivity of an application interface;
receive calls from a network;
automatically forward the received call when the application interface is inactive.

14. The computer-readable medium of claim 13, wherein the inactivity of the application interface is determined through a screen saver.

15. The computer-readable medium of claim 14, wherein the automatic forwarding is accomplished through deregistering a telephone interface from receiving calls.

16. The computer-readable medium of claim 15, wherein the received call is forwarded is to another device.

17. The computer-readable medium of claim 15, wherein the received call is forwarded is to voice mail.

18. The computer-readable medium of claim 15, wherein deregistering of the telephone interface is accomplished through the Session Initiation Protocol.

19. An apparatus comprising:
means for determining the inactivity of an application interface;
means for receiving calls from a network;
means for automatically forwarding the received call when the application interface is inactive.

20. The method of claim 19, wherein the means for determining the inactivity of the application interface is a screen saver.

21. The method of claim 20, wherein the automatic forwarding is accomplished through deregistering a telephone interface from receiving calls.

22. The method of claim 9, wherein the received call is forwarded is to another device.

23. The method of claim 21, wherein the received call is forwarded is to voice mail.

24. The method of claim 21, wherein deregistering of the telephone interface is accomplished through the Session Initiation Protocol.
